(19) United States
(12) Patent Application Publication
(10) Pub. No.: US 2003/0170040 A1
(43) Pub. Date: Sep. 11, 2003

(54) Copy machine printer interface system and associated method

(76) Inventor: Basil Makhoul, Melbourne, FL (US)

Correspondence Address: ASHKAN NAJAFI, P.A., 2615 SCOTT MILL DRIVE SOUTH, JACKSONVILLE, FL, 32223, US

(21) Appl. No.: 10/382,024

(22) Filed: Mar. 5, 2003

Related U.S. Application Data
(60) Provisional application No. 60/361,851, filed on Mar. 6, 2002.

(51) Int. Cl. G03G 21/02

(52) U.S. Cl. 399/79

(57) ABSTRACT

A copy machine printer interface system includes an interface device connectable to a copy machine. The system receives input for counting a number of copies made by a user on a copy machine and transmits an output indicating a number of copies made by a user. A printer is connectable to the interface and prints a receipt based upon the output received from the interface. The receipt may include a bar code that is readable by a bar code reading device.

### CROSS REFERENCE TO RELATED APPLICATIONS

This patent application claims the benefit of the earlier filed provisional patent application serial No. 60/361,851, filed on Mar. 6, 2002, and entitled “Copy Machine Printer Interface (C.M.P.I.)”.

### STATEMENT REGARDING FEDERALLY SPONSORED RESEARCH OR DEVELOPMENT

Not Applicable.

### REFERENCE TO A MICROFICHE APPENDIX

Not Applicable.

BACKGROUND OF THE INVENTION

1. Technical Field

This invention relates to a copy machine printer interface system and, more particularly, to a copy machine printer interface system for printing a receipt with a bar code that indicates the number of copies made by a user.

2. Prior Art

Most photocopy machines provide two main features to control the copier from a remote source. First, an “Enabling Connector” allows the copier to operate only when activated. A switch connected to this “Enabling Connector” is placed by the cash register, controlled by the store clerk. This prevents unauthorized usage of the machine. Second, a “Pulse Connector” generates a voltage signal when a copy is made. This signal could be sent to an external source to monitor the amount of copies made.

There are several methods commonly used in stores for billing customers for copies made. For example, one method includes a “display counter” placed close to the cash register that tells the store clerk how many copies the customer made. This counter is activated by a voltage signal generated from the copy machine that increments the count every time a copy is made. The clerk then bills the customer according to the number of copies made as displayed on the “display counter”. This method is ideal only for stores that have one clerk station for this display counter can only be placed at one location.

A second method includes a device that plugs into the copy machine, collects data on number of copies made by the customer, then when transferred to the register displays the total number of copies made and the billing amount. This method requires complex devices and a procedure where a customer must first obtain from the clerk a special plug-in device or card where the data is transferred onto by the copy machine to be read by another device at the register. The customer is billed according to what the device states and most likely would not be credited for bad copies made.

A third method includes coin operated machines having a means where coins are deposited directly into the copy machine system allowing the customer to print copies based on the amount of money deposited. This is ideal for customers that have a few copies to make due to the process of depositing coins per copy needed.

Such prior art attempts are expensive and require periodic repairs. Therefore, there is a need to provide a system for monitoring the number of copies a user makes and printing a bar code receipt for the user. Such a bar code receipt should be readable at conventional registers where the user can pay for the copies.

### BRIEF SUMMARY OF THE INVENTION

In view of the foregoing background, it is therefore an object of the present invention to provide copy machine printer interface system and associated method that has the above-mentioned characteristics. These and other objects, features, and advantages of the invention are provided by a copy machine printer interface system including an interface device connectable to a copy machine. The interface device includes means for receiving input for counting a number of copies made by a user on a copy machine and means for transmitting an output indicating a number of copies made by a user. The system further includes a printer connectable to the interface and for printing a receipt based upon the output received from the interface. The receipt is preferably readable at a cash register so that a user can pay for the copies thereat.

The printer may be a dot impact or a thermal head printer using receipt size paper rolls. The printer may also include a copy machine controller interface for connecting to a digital copy machine so that same can print receipts for the number of copies made by an user. The printer may print receipts on pre-printed UPC bar code paper indicating a vendor product number. The interface device may further include a microprocessor disposed therewithin.

The present invention may include a copy machine printer interface system including an interface device connectable to a pulse generating device and including means for counting and storing pulses indicating a number of copies made by a user on a copy machine. Such a system may further include a printer connected to the interface device and for printing a receipt indicating the number of pulses counted and stored by the interface device.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which.

FIG. 1 is a front view of a conventional copy machine provided with a copy machine printer interface system, in accordance with the present invention;

FIG. 2 is a flow chart illustrating the process for capturing the number of copies made by a user and printing a bar coded receipt for such copies; and

FIG. 3 is a schematic view of the microprocessor employed by the copy printer interface system.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art.

The reason for this invention is to make the self-service copy process easier and more flexible for the customer where it concerns paying for the copies made. The customer does not have to wait for a clerk to obtain a special device prior to copying, or constantly inserting coins to activate the machine, or pay for all copies regardless of any error copies made. This invention provides a printed receipt on completion of the copy job, where the customer takes it to any register, scans a preprinted bar code on the receipt to indicate item description, then the clerk enters the number of copies made as presented. If error copies where made, the clerk can deduct them from the total number presented.

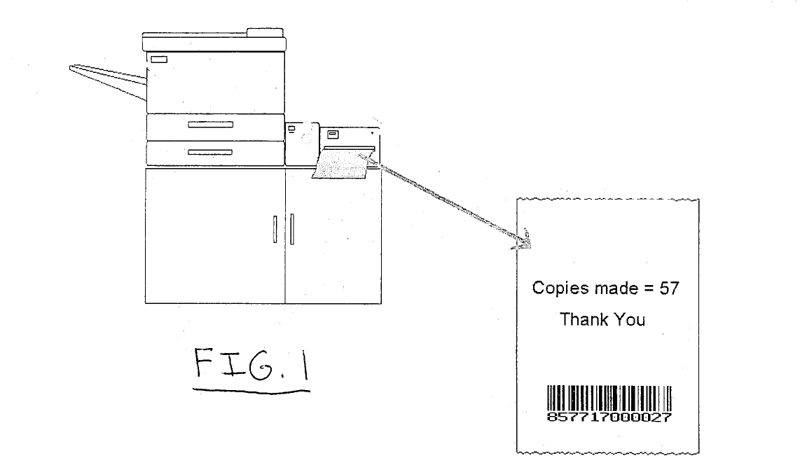

As shown in FIG. 1, this invention acts as an interface between a copy machine and a printer, thus called: Copy Machine Printer Interface or CMPI, receives the pulses generated from the copy machine, increments its built in digital counter that indicates the number of copies made, and generates hexadecimal computer codes when the “Print Receipt” button is pressed by the customer, hence indicating end of the print job. These codes are generated by a built in microprocessor similar to those formed by a computer, then sent to the serial port of the receipt printer to print a receipt containing data describing the number of copies the customer made. The customer takes this receipt to any cash register to enter the data as a regular item sold in the store and thus billed accordingly.

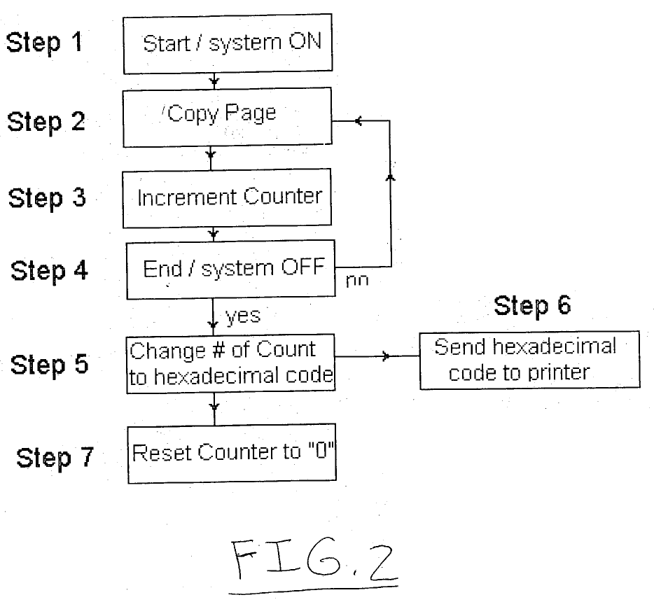

FIG. 2 shows a flow chart of the control sequence. Step (1): Start/system ON: A customer presses a toggle switch connected to the “enable connector” to “ON” that enables the copy machine to print. Step (2): Copy Page: Customer presses the “print” button on the copier to make a copy. Step (3): Increment Counter: The CMPI keeps track of a copies made by receiving a voltage signal from the “pulse connector” of the copy machine and adds 1 to the past count during this step. Step (4): End/system OFF: Has the customer finished his copies? If no, then he makes another copy that increments the counter once again. If yes, then he is done with using the copy machine, turns the toggle switch back to “OFF,” that stops the machine's printing ability.

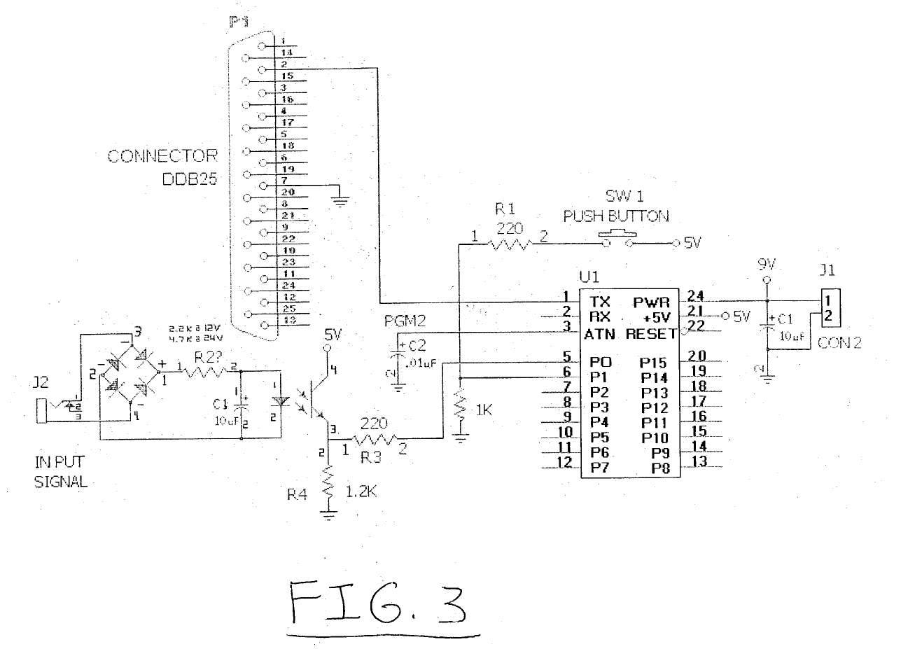

Step (5): Change # of Count to hexadecimal code: The number of counts is then transferred to hexadecimal command codes that the printer can execute similar to the print command codes sent by a computer. Step (6): Send hexadecimal code to printer: Lines of code are sent to the printer resulting in a printed receipt containing the number of copies made by the customer. These codes are generated by a built in microprocessor, shown in FIG. 3, similar to those formed by a computer, then sent to the serial port of the receipt printer to print a receipt containing data describing the number of copies the customer made. The customer then takes this receipt to the cash register for payment. Step (7): Reset Counter to “0”: This step resets the copy count back to zero, ready for the next customer.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. A copy machine printer interface system comprising:
an interface device connectable to a copy machine and including
means for receiving an input for counting a number of copies made by a user on a copy machine, and
means for transmitting an output indicating a number of copies made by an user; and
a printer connectable to said interface and for printing a receipt based upon the output received from said interface, the receipt is readable at a cash register so that a user can pay for the copies thereat.

2. The copy machine printer interface system of claim 1, wherein said printer is one of a dot impact and thermal head printer using receipt size paper rolls.

3. The copy machine printer interface system of claim 2, where said printer includes a copy machine controller interface for connecting to a digital copy machine so that same can print receipts for a number of copies made by an user.

4. The copy machine printer interface system of claim 1, wherein said printer prints receipts on pre-printed UPC bar code paper indicating a vendor product number.

5. The copy machine printer interface system of claim 1, wherein said interface includes a microprocessor disposed therewithin.

6. A copy machine printer interface system comprising
an interface device connectable to a pulse generating device and including means for counting and storing pulses indicating a number of copies made by a user on a copy machine; and
a printer connected to said interface device and for printing a receipt indicating the number of pulses counted and stored by said interface device.
